(19) United States
(12) Patent Application Publication
(10) Pub. No.: US 2005/0137875 A1
(43) Pub. Date: Jun. 23, 2005

(54) Method for converting a voiceXML document into an XHTMLdocument and multimodal service system using the same

(76) Inventors: Ji Eun Kim, Taejon (KR); Ji Eun Park, Taejon (KR); Jun Seok Park, Taejon (KR); Dong Won Han, Taejon (KR)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/824,483

(22) Filed: Apr. 15, 2004

(30) Foreign Application Priority Data
Dec. 23, 2003 (KR) 2003 - 95258

(51) Int. Cl. G10L 11/00

(52) U.S. Cl. 704/270.1

(57) ABSTRACT

The present invention relates to a method and system for converting a VoiceXML-based voice service into an XHTML+Voice-based multimodal service. A conversion method of the present invention includes the steps of: scanning the VoiceXML tree from an upper tag to a lower tag with initializing the XHTML+Voice tree; checking a tag, and if the tag is <menu>, converting the tag <menu> into a tag <a> of the XHTML; checking the tag, and if the tag is <grammar>, converting the tag <grammar> into a tag <input type=radio> of the XHTML; and checking the tag, and if the tag is <form>, adding the tag <form> of XHTML to the XHTML tree and processing the tag <form>. A multimodal service system according to the present invention can use additional external system such as a proxy server or an XHTML+Voice browser of a general user device can include a transcoder implementing the above conversion method or a partial module of the transcoder.

### BACKGROUND OF THE INVENTION

1. Field of the Invention

The present invention relates to a method and system for converting a Voice extensible Markup Language (VoiceXML)-based voice service into an extensible HyperText Markup Language (XHTML)+Voice-based multimodal service that supports an XHTML-based web interface and a VoiceXML-based voice interface.

2. Description of the Related Art

In general, VoiceXML is a spoken dialogue scenario composition standard language in which web information process technology is combined with speech recognition and text-to-speech technology and computer telephony integration technology. In other words, VoiceXML is an XML-based markup language used to define spoken dialog that allows a user to search for Internet information by speech by means of a wire or mobile telephone. The VoiceXML document allows a user to search Internet for e-mail, weather information and traffic information, etc. through a wire or mobile telephone without Internet connection devices such as a notebook computer and a personal computer and can provide the user with contents of a web page in speech.

Accordingly, since the VoiceXML can create and maintain a service through web in real time, it is regarded as the core technology of a next generation speech service that can substitute for a dialogue speech service system such as the conventional automatic response service (ARS) and interactive voice response (IVR).

FIG. 1 illustrates a voiceXML-based speech service system on telephone network. Users 102-1 and 102-2, a Public Switched Telephone Network (PSTN) 104, an IVR 106, Internet 108, voice gateway 110 and a web server 120 are depicted in FIG. 1. The user 102-1 uses a speech web service by means of a wire or mobile telephone. The user 102-2 can connect to a web server through a personal computer to use a general web service. The web server 120 includes a VoiceXML application 122 as well as general web pages. The web server 120 provides the web page to the user 102-2 through Internet and supplies the user 102-2 with a VoiceXML document at the request of the voice gateway 110 for HTTP. The voice gateway 110 includes a Voice-XML browser 112, a speech recognizer/synthesizer 114 and a script engine 116. The voice gateway 110 submits an HTTP request to request the web server 120 to supply a voice web document at the request of the user 102-1. When the voice gateway 110 receives the VoiceXML document, the voice gateway 110 executes the VoiceXML document by means of the VoiceXML browser 112 and transmits the voice to a user through the PSTN 104 by using the speech recognizer/synthesizer 114.

The operation of such speech web service using telephone network is as follows.

First, the user 102-1 connects to a voice gateway 110 through a wire or mobile communication terminal by using a representative phone number. The voiceXML browser 112 of the voice gateway 110 requests the web-server 120 to provide the VoiceXML document. The web-server 120 transmits the corresponding VoiceXML document to the voice gateway 110. The VoiceXML browser 112 of the voice gateway 110 interprets and executes the received VoiceXML document, and provides the user 102-1 with the speech output of the executed VoiceXML document through the phone network 104.

In the meanwhile, if the user wants to use various VoiceXML-based speech services provided in various applications (for example, securities, credit cards, distribution, etc.) by means of an Internet browser in a PDA, a smart phone or a personal computer, a predetermined conversion is required. Here, since “using a service by means of the Internet browser” means that an interface as well as a voice in view of property of device, variation of a user interface should be considered in conversion process.

XHTML+Voice was suggested as a markup language to meet such requirements. XHTML+Voice was proposed to develop a multimodal web service in which XHTML-based web service and voiceXML (a subset of VoiceXML 2.0)-based speech service are combined with each other. XHTML+Voice document composition is similar to the conventional XHTML document composition and VoiceXML document composition but the speech-relevant tags are executed in relation with XML event and XHTML+Voice event. Accordingly, if a user wants to use the currently provided VoiceXML-based speech service as a multimodal service by means of an Internet browser of a PDA, a smart phone or a personal computer, the process to convert the conventional VoiceXML document into XHTML+Voice document is required.

### SUMMARY OF THE INVENTION

Accordingly, the present invention is directed to a method for converting a voiceXML document into an XHTML+voice document and multimodal service using the same, which substantially obviates one or more problems due to limitations and disadvantages of the related art.

It is an object of the present invention to provide a method for converting a voiceXML document into an XHTML+voice document by using a predetermined conversion algorithm and a multimodal service system using the same.

Additional advantages, objects, and features of the invention will be set forth in part in the description which follows and in part will become apparent to those having ordinary skill in the art upon examination of the following or may be learnt from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for converting a Voice VoiceXML tree generated after parsing a VoiceXML document into an XHTML+Voice tree, including the steps of: (a) scanning the VoiceXML tree from an upper tag to a lower tag with initializing the XHTML+Voice tree; (b) checking a tag, and if the tag is <menu>, converting the tag <menu> into a tag <a> of the XHTML; (c) checking the tag, and if the tag is <grammar>, converting the tag <grammar> into a tag <input type=radio> of the XHTML; and (d) checking the tag, and if the tag is <form>, adding the tag <form> of XHTML to the XHTML tree and processing the tag <form>.

In another aspect of the present invention, there is provided a multimodal service method using a system that comprises a user terminal equipped with a general XHTML+Voice browser, a proxy server and a web server providing a VoiceXML document, and converts a VoiceXML document into an XHTML+Voice document, including the steps of: executing the XHTML+Voice browser and requesting the web server to provide the VoiceXML document by submitting HTTP request, at the user terminal; transmitting the VoiceXML document to the proxy server from the web server; creating a VoiceXML tree from the received VoiceXML document at a VoiceXML parser installed in the proxy server, and transmitting the VoiceXML tree from the VoiceXML parser to a VoiceXML-to-XHTML+Voice converter; converting the received VoiceXML tree into a new XHTML+Voice tree by means of a predetermined algorithm at the VoiceXML-to-XHTML+Voice converter, and transmitting the converted XHTML+Voice tree from the VoiceXML-to-XHTML+Voice converter to an XHTML+Voice document generator; receiving the XHTML+Voice tree and generating an XHTML+Voice document at an XHTML+Voice document generator to transmit the generated XHTML+Voice document from the XHTML+Voice document generator to the XHTML+Voice browser; and interpreting and executing the XHTML+Voice document at the user XHTML+Voice browser to output speech and graphic.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates a voiceXML-based speech service system on telephone network;

FIG. 2 is a block diagram illustrating operation of a proxy server in which a transcoder according to the present invention is implemented;

FIG. 3 is a block diagram illustrating operation of an XHTML+Voice browser in which a VoiceXML-to-XHTML+Voice converter is embedded as a module of a transcoder according to the present invention;

FIG. 4 is a flowchart of an algorithm of a VoiceXML-to-XHTML+Voice converter that is a module of a transcoder according to the present invention;

FIG. 5 shows screens of an XHTML+Voice browser executing an exemplary speech scenario before conversion and after conversion according to the present invention;

FIG. 6 illustrates VoiceXML document structure of the exemplary speech scenario of FIG. 5;

FIG. 7 illustrates a VoiceXML tree and an XHTML+Voice tree converted and generated according to the present invention; and

FIG. 8 illustrates XHTML+Voice document structure generated from an XHTML+Voice tree according to the present invention.

### DETAILED DESCRIPTION OF THE INVENTION

Reference will now be made in detail to the preferred embodiments of the present invention, examples of which are illustrated in the accompanying drawings.

A module for converting a VoiceXML document into an XHTML+Voice document according to the present invention (hereinafter, referred to as ‘VoiceXML-to-XHTML+Voice converter’) can be embedded in an XHTML+Voice browser of a user device (Embodiment 2). If the user device that does not use the XHTML+Voice browser having the VoiceXML-to-XHTML+Voice converter of the present invention wants to a speech service, the user device should receive an XHTML+Voice document converted through a proxy server in which a transcoder equipped with the VoiceXML-to-XHTML+Voice converter of the present invention operates (Embodiment 1).

### EMBODIMENT 1

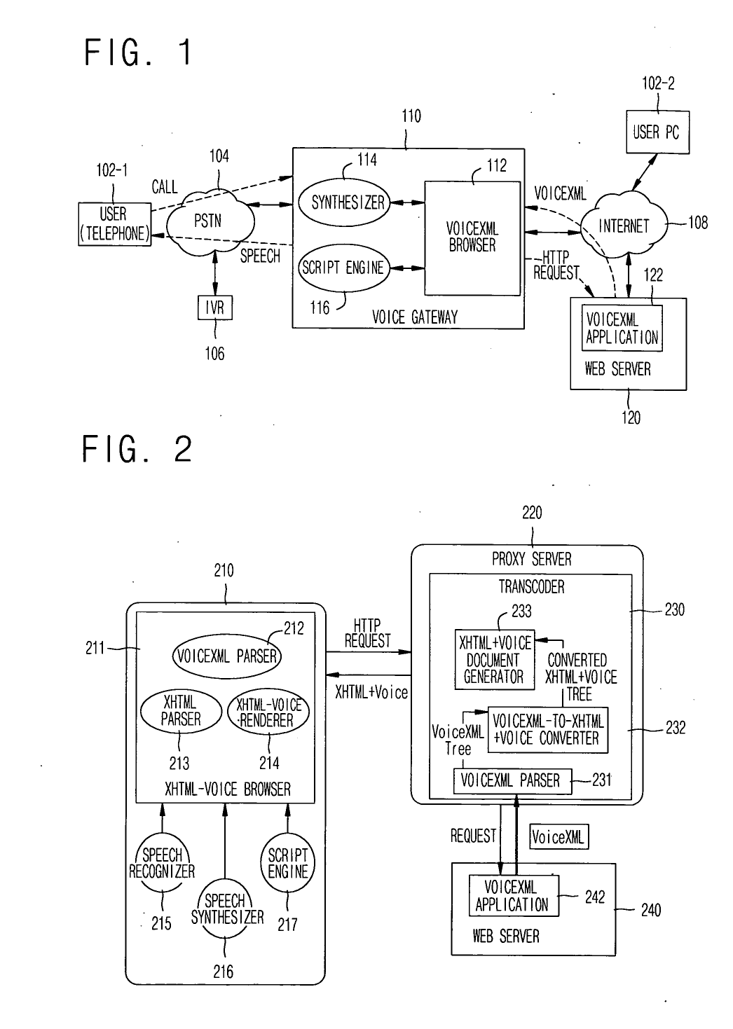

FIG. 2 illustrates a case in which the proxy server h a s a transcoder of the present invention. FIG. 2 illustrates the relation among a user 210, a proxy server 220 and a web server 240. The user 210 includes an XHTML+Voice browser 211, a speech recognizer 215, a speech synthesizer 216 and a script engine 217. The proxy server 220 has a transcoder 230. The transcoder 230 includes a VoiceXML parser 231, a VoiceXML-to-XHTML+Voice converter 232 and an XHTML+Voice document generator 233. The web server 240 has a VoiceXML application 242.

Referring to FIG. 2, a general XHTML+Voice browser 211 includes an XHTML parser 213, a VoiceXML parser 212, and an XHTML-Voice renderer 214. The XHTML parser 213 creates an XHTML tree from an XHTML document. The VoiceXML parser 212 creates a VoiceXML tree from a VoiceXML document. The XHTML-Voice renderer 214 executes each tree to perform interaction. The XHTML+Voice browser 211 processes ECMA script by-using a script engine 217, outputs speech by using a speech synthesizer 216, and processes inputted speech by using a speech recognizer 215. The XHTML+Voice browser 211 processes a text input from a touch screen, a hardware keyboard, etc.

A service provider creates a speech service and provides the created speech service through the web server 240. If the web server 240 receives HTTP request from the proxy server 220 through the VoiceXML application 242, the web server 240 transmits the corresponding VoiceXML document.

The proxy server 220 includes a transcoder 230 for converting a VoiceXML document into an XHTML+Voice document. The transcoder 230 of the present invention includes a VoiceXML parser 231 for generating a VoiceXML tree, a VoiceXML-to-XHTML+Voice converter 232 for implementing a predetermined conversion algorithm, and an XHTML+Voice document generator 233 for converting an XHTML+Voice tree into an XHTML+Voice document.

The process for providing a multimadal service to a user 210 who uses the general XHTML-Voice browser 211 by means of the transcoder 230 of the present invention is as follows.

The user 210 operates the XHTML-Voice browser 211 through a terminal such as a PDA and a smart phone. Sequentially, the user 210 requests the web server 240 to provide VoiceXML document by submitting HTTP request. The web server 240 transmits the VoiceXML document to the proxy server 220.

The VoiceXML parser 231 installed in the proxy server 220 creates a VoiceXML tree from the received VoiceXML document, and transmits the created VoiceXML tree to the VoiceXML-to-XHTML+Voice converter 232.

The VoiceXML-to-XHTML+Voice converter 232 converts the received VoiceXML tree into a new XHTML+Voice tree by means of a predetermined algorithm, and transmitting the converted XHTML+Voice tree to the XHTML+Voice document generator 233. The XHTML+Voice document generator 233 receives the XHTML+Voice tree, generates an XHTML+Voice document, and transmits the generated XHTML+Voice document to the XHTML+Voice browser 211.

Finally, the XHTML+Voice browser 211 of the user 210 interprets and executes the XHTML+Voice document to output speech and graphic.

### EMBODIMENT 2

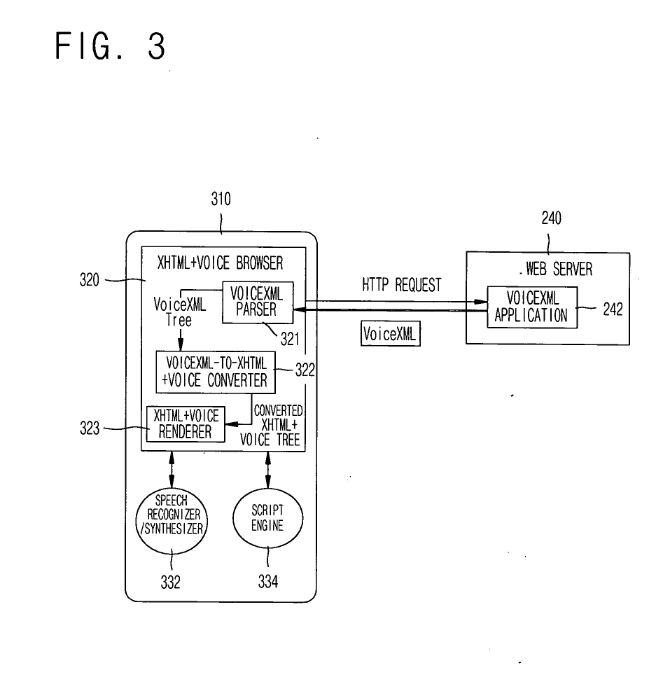

FIG. 3 is a block diagram illustrating the case that a VoiceXML-to-XHTML+Voice converter is embedded in an XHTML+Voice browser. FIG. 3 illustrates the relation between a user 310 and the web server 240.

Referring to FIG. 3, the terminal of the user 310 is equipped with an XHTML+Voice browser 320, a speech recognizer/synthesizer (TTS & SRS) 332 and a script engine 334.

The XHTML+Voice browser 320 includes a VoiceXML parser 321, a VoiceXML-to-XHTML+Voice converter 322 and an XHTML+Voice renderer 323. The VoiceXML parser 321 generates a VoiceXML tree from a VoiceXML document. The VoiceXML-to-XHTML+Voice converter 322 generates an XHTML+Voice tree from the VoiceXML tree according to a predetermined conversion algorithm. The XHTML+Voice renderer 323 executes the XHTML+Voice tree to output speech through the recognizer/synthesizer 332. The script engine 334 processes an ECMA script.

The process for providing a multimadal service by using the XHTML+Voice browser 320 of the present invention is as follows.

The user 310 operates the XHTML-Voice browser 320 through a terminal such as a PDA and a smart phone. The XHTML+Voice browser 320 requests the web server 240 to provide VoiceXML document by submitting HTTP request. A VoiceXML application 242 of the web server 240 transmits the corresponding VoiceXML document to the XHTML+Voice browser 320.

The VoiceXML parser 321 of the XHTML+Voice browser 320 creates a VoiceXML tree from the received VoiceXML document, and transmits the created VoiceXML tree to the VoiceXML-to-XHTML+Voice converter 322. The VoiceXML-to-XHTML+Voice converter 322 converts the received VoiceXML tree into a new XHTML+Voice tree by means of a predetermined algorithm, and transmits the converted XHTML+Voice tree to the XHTML+Voice renderer 323. The XHTML+Voice renderer 323 interprets and executes the XHTML+Voice document to output speech and graphic.

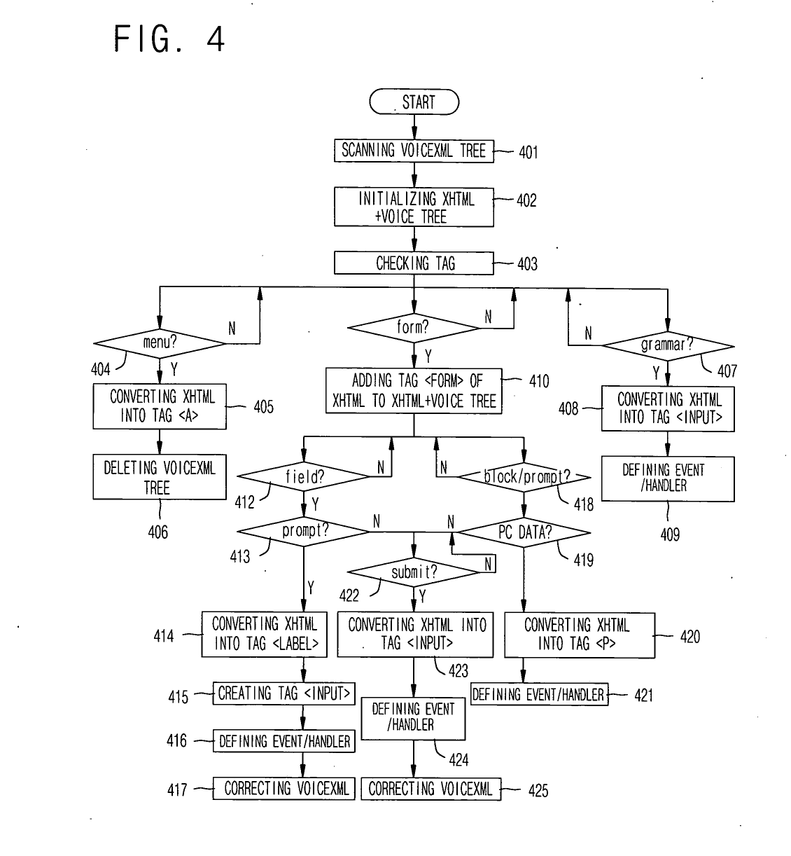

FIG. 4 is a flowchart of a conversion algorithm of a VoiceXML-to-XHTML+Voice converter according to the present invention.

Referring to FIG. 4, while all the VoiceXML tree is scanned from an upper tag to a lower tag, the XHTML+Voice tree is initialized (401 and 402). A main dialog among them is a newly created XHTML.

A tag is checked whether the tag is <menu>, <grammar> or <form> (403).

If the tag is <menu>, the tag <menu> is converted into a tag <a> of the XHTML and a VoiceXML tree is deleted (404-406).

If the tag is <grammar>, the tag <grammar> is converted into a tag <input type=radio> of the XHTML and an event/handler is defined (407-409).

If the tag is <form>, the tag <form> of XHTML is added to the XHTML tree (411). If tags <block> and <prompt> that belong to the one tag <form> are PC data, the tags <block> and <prompt> are converted into a tag <p> of the XHTML and the event/handler is defined (418-421).

A tag <prompt> which belongs to tags <form> and <field> is converted into a tag <label> of the XHTML, a tag <input type =text> is generated as a lower tag, the event/handler is defined and VoiceXML is corrected (412-417).

A tag <submit> which belongs to tags <form> and <field> or a tag <block> is converted into a tag <input type=submit> of the XHTML, the event/handler is defined and VoiceXML is corrected (422-425). As described above, a proper event is added to each process. The VoiceXML tree that is an object tree should be corrected or deleted.

To make it easy to understand the conversion algorithm of the present invention, it is confirmed through an example.

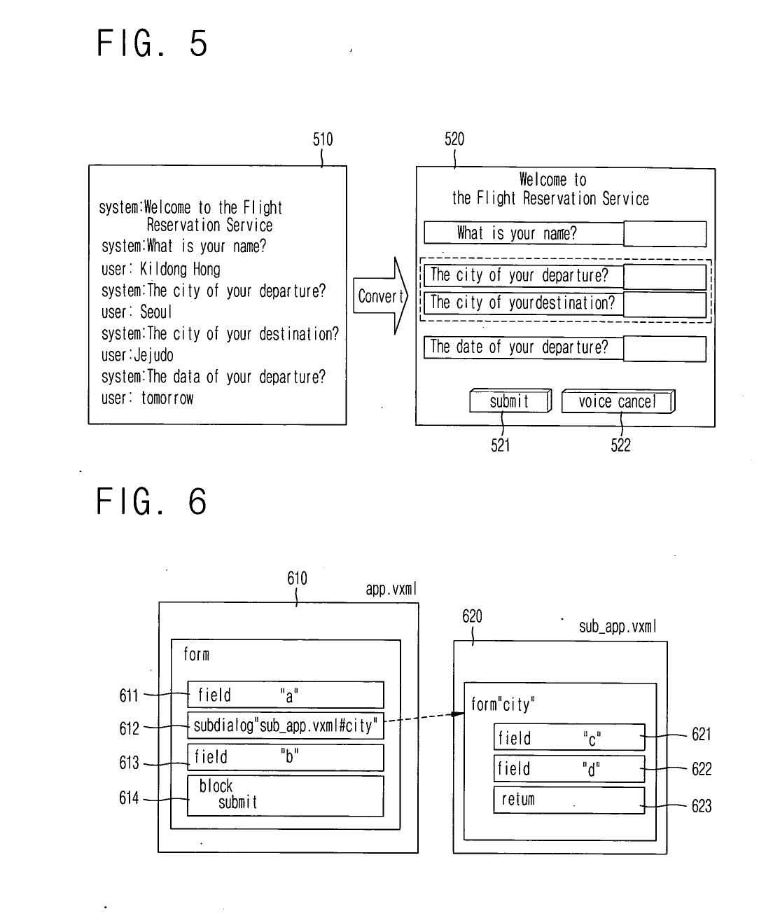

FIG. 5 shows screens of an XHTML+Voice browser executing an exemplary speech scenario before conversion and after conversion according to the present invention.

Referring to FIG. 5, the exemplary speech scenario before conversion is a scenario related to flight reservation and the user wants to use flight reservation service that is one of speech services provided through Internet by means of a PDA and a smart phone. A scenario 510 of flight reservation service provided by a service provider is configured to receive and process the answers of “What is your name?”, “The city of your departure?”, “The city of your destination?”, “The date of your departure?”, etc.

The VoiceXML document having the scenario described above is converted according to the present invention, and executed in the XHTML+Voice browser and displayed on a screen 520 as shown on the right portion of FIG. 5.

Since the XHTML+Voice browser screen 520 supports a speech use mode basically, the XHTML+Voice browser screen 520 reads the corresponding question in speech and get ready to receive a proper value in speech when a user clicks and focuses an input window. If the user clicks a voice cancel button 522 to selects a speech cancel mode, the user should input a value by using only text. After the user completed to input, the user clicks a submit button 521 to transmit input contents to next application program.

FIG. 6 illustrates VoiceXML document structure of the exemplary speech scenario of FIG. 5. The VoiceXML document of the exemplary speech scenario consists of a document app.vxml 610 that is a main dialog and a document sub_app.vxml 620 that is a subdialog.

Referring to FIG. 6, the main dialog app.vxml 610 has a <form>. The one <form> of the main dialog app.vxml 610 includes <field a> 611, <subdialog> 612, <field b> 613 and <submit> 614. The subdialog sub_app.vxml 620 has a <form>. The one <form> of the subdialog sub_app.vxml 620 includes <field c> 621, <field d> 622, and <return> 623. In the embodiment of the present invention, “Welcome to the Flight Reservation Service” belongs to a tag <block> but its description will be omitted.

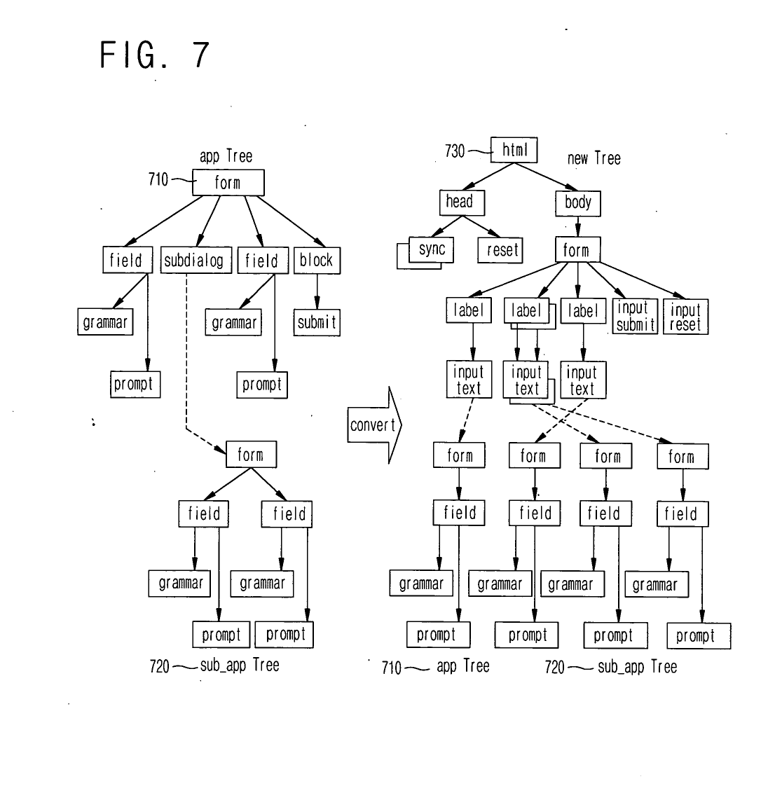

FIG. 7 illustrates a VoiceXML tree of the example speech scenario of FIG. 5 and an XHTML+Voice tree that is generated using conversion algorithm according to the present invention.

Referring to FIG. 7, the VoiceXML tree of the example speech scenario consists of app tree 710 and a sub_app tree 720. They are converted into a converted app tree 710′ and a converted sub_app tree 720′, and new tree 730 is generated by a conversion algorithm of the present invention.

The app tree 710 has a form. The one form of the app tree 710 consists of a first field, a subdialog, a second field and a block. The sub_app tree 720 has a form. The one form of the sub_app tree 720 consists of two fields.

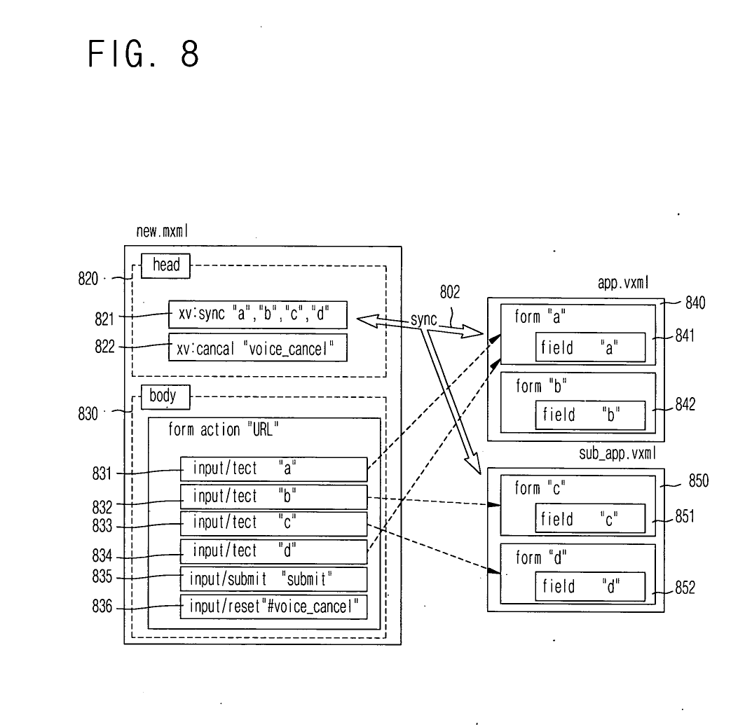

FIG. 8 illustrates XHTML+Voice document structure generated from an XHTML+Voice tree of FIG. 7.

Referring to FIG. 8, a main dialog new.vxml 810 has a tag <head> 820 and a tag <body> 830 as a basic structure in a highest tag <html>.

The tag <head> 820 has a tag <xv:sync> 821 and a tag <xv:cancel> 822. The tag <xv:sync> 821 is used to synchronize (802) a tag <field> of a voice document and a tag <input> of the tag <body>. The tag <xv:cancel> 822 is used to process speech cancel mode.

The tag <body> 830 has a tag <form>. The one tag <form> consists of a tag <input type=text a> 831, a tag <input type=text c> 832, a tag <input type=text d> 833, a tag <input type=text b> 834, a tag <input type=submit> 835 and a tag <input type=reset> 836. The tag <input type=text a> 831, the tag <input type=text c> 832, the tag <input type=text d> 833, the tag <input type=text b> 834 are converted from a tag <field>. The tag <input type=submit> 835 is converted from a tag <submit>. The tag <input type=reset> 836 is used for speech cancel mode.

The app.vxml 840 is modified to be a subdialog that has a tag <field a> in a tag <form a> 841 and a tag <field b> in a tag <form b> 842. The sub_app.vxml 850 is modified to be a subdialog that has a tag <field c> in a tag <form c> 851 and a tag <field d> in a tag <form d> 852.

As described above, the VoiceXML-to-XHTML+Voice converter of the present invention and a transcoder including the VoiceXML-to-XHTML+Voice converter converts a VoiceXML tag into an XHTML+Voice tag by one-to-one as possible. However, the call control tag which cannot convert a VoiceXML tag into an XHTML+Voice tag by one-to-one can solve the problem by using a script or an application program to control a system or deleting the tag. The VoiceXML-to-XHTML+Voice converter of the present invention may be embedded in a user device or separately established by a system such as a proxy server with a transcoder to provide a service adapted to user environment.

Also, a service provider automatically converts a VoiceXML service-based speech service for a telephone network into an XHTML+Voice multimodal service for Internet in real time, so that a multimodal service can be easily implemented using the conventional VoiceXML-based speech service. In other words, though a service for a intelligence information type device such as a PDA or a smart phone is not developed again, the multimodal service can be implemented with low cost. Maintenance for the VoiceXML-based speech service substitutes for maintenance for the multimodal service automatically, so that additional cost for maintenance for the multimodal service is hardly necessary.

Further, the service user can perform interaction not through a single modal interface but through a multimodal interface in using speech service through Internet, control a service not serially but in parallel, and select a desired mode through a mode switch (determining whether to use speech mode or not). As a result, since user overexertion is reduced, the speech service can be used more exactly and more efficiently.

In the meanwhile, as a speech service adapted to the present invention, there are a real time information service for weather, news, securities and traffic information, a service having sequential contents such as cooking, emergency measures for an emergent patient, various census services such as public opinion poll, audience measurement and consumer information measurement, and a banking service such as balance reference and various bank goods information reference.

It will be apparent to those skilled in the art that various modifications and variations can be made in the present invention. Thus, it is intended that the present invention covers the modifications and variations of this invention provided they come within the scope of the appended claims and their equivalents.

1. A method for converting a Voice eXtensible Markup Language (VoiceXML) tree generated after parsing a VoiceXML document into an extensible HyperText Markup Language (XHTML)+Voice tree, the method comprising the steps of:
(a) scanning the VoiceXML tree from an upper tag to a lower tag with initializing the XHTML+Voice tree;
(b) checking a tag;
(c) if the tag is <menu>, converting the tag <menu> into a tag <a> of the XHTML;
(d) if the tag is <grammar>, converting the tag <grammar> into a tag <input type=radio> of the XHTML; and
(e) if the tag is <form>, adding the tag <form> of XHTML to the XHTML tree and processing the tag <form>.

2. The method of claim 1, wherein the step (d) comprises the steps of:
(d-1) converting tags <block> and <prompt> that belong to the one tag <form> into a tag <p> of the XHTML;
(d-2) converting a tag <prompt> which belongs to tags <form> and <field> into a tag <label> of the XHTML; and
(d-3) converting a tag <submit> which belongs to tags <form> and <field> or a tag <block> into a tag <input type=submit> of the XHTML.

3. The method of claim 1, wherein, in each of the steps (d), an event/handler is defined after conversion, or the VoiceXML is corrected or deleted.

4. The method of claim 2, wherein, in each of the steps (d), an event/handler is defined after conversion, or the VoiceXML is corrected or deleted.

5. A multimodal service method using a system that comprises a user terminal equipped with a general XHTML+Voice browser, a proxy server and a web server providing a VoiceXML document, and converts a VoiceXML document into an XHTML+Voice document, the method comprising the steps of:
executing the XHTML+Voice browser and requesting the web server to provide the VoiceXML document by submitting HTTP request, at the user terminal;
transmitting the VoiceXML document to the proxy server from the web server;
creating a VoiceXML tree from the received VoiceXML document at a VoiceXML parser installed in the proxy server, and transmitting the VoiceXML tree from the VoiceXML parser to a VoiceXML-to-XHTML+Voice converter;
converting the received VoiceXML tree into a new XHTML+Voice tree by means of a predetermined algorithm at the VoiceXML-to-XHTML+Voice converter, and transmitting the converted XHTML+Voice tree from the VoiceXML-to-XHTML+Voice converter to an XHTML+Voice document generator;
receiving the XHTML+Voice tree and generating an XHTML+Voice document at an XHTML+Voice document generator to transmit the generated XHTML+Voice document from the XHTML+Voice document generator to the XHTML+Voice browser; and
interpreting and executing the XHTML+Voice document at the user XHTML+Voice browser to output speech and graphic.

6. A multimodal service method using a system that comprises a user terminal equipped with an XHTML+Voice browser having a VoiceXML-to-XHTML+Voice converter, and a web server providing a VoiceXML document, and converts a VoiceXML document into an XHTML+Voice document, the method comprising the steps of:
executing the XHTML+Voice browser and requesting the web server to provide the VoiceXML document by submitting HTTP request, at the user terminal;
transmitting the corresponding VoiceXML document to the XHTML+Voice browser from the web server;
creating a VoiceXML tree from the received VoiceXML document at a VoiceXML parser of the XHTML+Voice browser, and transmitting the created VoiceXML tree from the VoiceXML parser to a VoiceXML-to-XHTML+Voice converter;
converting the received VoiceXML tree into a new XHTML+Voice tree by means of a predetermined algorithm at the VoiceXML-to-XHTML+Voice converter; and
interpreting and executing the XHTML+Voice document at an XHTML+Voice renderer to output speech and graphic.

7. A multimodal service system that comprises a user terminal equipped with an XHTML+Voice browser, a proxy server and a web server providing a VoiceXML document, the proxy server being equipped with a transcoder, wherein the transcoder comprises:
a VoiceXML parser for generating a VoiceXML tree;
a VoiceXML-to-XHTML+Voice converter for implementing a predetermined conversion algorithm; and
an XHTML+Voice document generator for converting an XHTML+Voice tree into an XHTML+Voice document.

8. A multimodal service system that comprises a user terminal equipped with an XHTML+Voice browser, and a web server providing a VoiceXML document, wherein the XHTML+Voice browser comprises:
a VoiceXML parser for generating a VoiceXML tree from a VoiceXML document;
a VoiceXML-to-XHTML+Voice converter for generating XHTML+Voice tree from the VoiceXML tree according to a predetermined conversion algorithm; and
an XHTML+Voice renderer for executing the XHTML+Voice tree.

9. The system of claim 8, wherein a speech service provided through the XHTML+Voice browser is browsed as a multimodal service; and
in the speech service, one of a speech input/output use mode and a speech input/output cancel mode can be selected.

10. The system of claim 7, wherein the VoiceXML-to-XHTML+Voice converter scans the VoiceXML tree from an upper tag to a lower tag with checking a tag, if the tag is <menu>, converts the tag <menu> into a tag <a> of the XHTML, if the tag is <grammar>, converts the tag <grammar> into a tag <input type=radio> of the XHTML, and if the tag is <form>, adds the tag <form> of XHTML to the XHTML tree and processes the tag <form>.

11. The system of claim 8, wherein the VoiceXML-to-XHTML+Voice converter scans the VoiceXML tree from an upper tag to a lower tag with checking a tag, if the tag is <menu>, converts the tag <menu> into a tag <a> of the XHTML, if the tag is <grammar>, converts the tag <grammar> into a tag <input type=radio> of the XHTML, and if the tag is <form>, adds the tag <form> of XHTML to the XHTML tree and processes the tag <form>.
